(19) United States
(12) Patent Application Publication
(10) Pub. No.: US 2010/0278314 A1
(43) Pub. Date: Nov. 4, 2010

(54) METHOD AND APPARATUS FOR DISSEMENATING INFORMATION RELATING TO A LOCAL EMERGENCY CONDITION

(76) Inventors: Stuart O. Goldman, Scottsdale, AZ (US); Karl F. Rauscher, Emmaus, PA (US)

Correspondence Address: FAY SHARPE/LUCENT, 1228 Euclid Avenue, 5th Floor, The Halle Building, Cleveland, OH, 44115-1843, US

(21) Appl. No.: 12/638,126

(22) Filed: Dec. 15, 2009

Related U.S. Application Data
(60) Provisional application No. 61/215,323, filed on May 4, 2009.

(51) Int. Cl. H04M 11/04

(52) U.S. Cl. 379/45

(57) ABSTRACT

A method for disseminating information relating to a local emergency condition includes: a) receiving an incoming message from a user device directed to a destination device within a emergency response organization; b) determining if the incoming message can be connected to the destination device without wait time; and c) sending an outgoing message to the user device if the incoming message cannot be connected without wait time. The outgoing message may provide a status report for the local emergency condition within a geographic area served by the emergency response organization and a guidance report with a response measure. A network node associated with the method may include an incoming message module for receiving the incoming message, a message handling module for determining if the incoming message can be connected to the destination device without wait time, and an outgoing message module for sending the outgoing message to the user device.

### CROSS-REFERENCE TO RELATED APPLICATIONS

This application claims the right of priority and any benefit associated with, U.S. Provisional Pat. App. Ser. No. 61/215,323, filed May 4, 2009, the entire contents of which are fully incorporated herein by reference.

### BACKGROUND

This disclosure relates to a method and apparatus for disseminating information relating to a local emergency condition to originators of incoming messages to an emergency response organization that cannot be promptly serviced. For example, this disclosure describes exemplary embodiments for providing the incoming message originator with status and guidance information before releasing the message and returning a destination busy indication. However, it will be appreciated that the disclosed concepts may have usefulness in providing the status and guidance information while the incoming message is queued and the originator is waiting for the incoming message to be serviced. Moreover, the status and guidance information may be provided before the incoming message is routed to another emergency response organization if the original emergency response organization is already at capacity.

By way of background, the primary purpose of an incoming message to an emergency response organization (e.g., 911 calls in the United States, 112 calls in the European Union) is to connect an originator of the incoming message with a message taker (e.g., call taker) at the emergency response organization (e.g., public safety answering point (PSAP)) so that the originator can request assistance for an emergency, such as medical, fire, or rescue emergency. Depending on the nature of the emergency, the message taker focuses on dispatching assistance to the specific message originator.

An incoming message directed to an emergency response organization is normally answered rapidly by a message taker at the emergency response organization. However, during mass events there may be more incoming messages arriving than can be handled by the message takers. First, the incoming messages may be queued up or stored in a message queue or buffer. If even more messages come in that cannot be serviced by message takers, the capacity of the message queue may be exceeded and the messages may either be redirected to an adjacent or alternate emergency response organization or released with reorder tone (e.g., slow busy tone). This is the reality of not having enough message takers in light of the increased demand caused by the mass event or local emergency condition. Obviously, these results do not resolve the emergency situation that caused the originator to initiate the incoming message in the first place.

In the absence of any better guidance, upon getting a reorder tone, the originator may initiate a new incoming message to the emergency response organization. This may be repeated continuously until the originator's need is satisfied or until they give up in frustration without the need being satisfied. In mass emergencies, the originator may be wasting time making such repeated attempts to contact the emergency response organization rather than taking action to avoid or reduce the risk posed by the emergency condition.

Part of the message congestion problem is because there is no procedure in place for separating out calls for general information from calls for specific help, such as the dispatch of an emergency vehicle. Therefore, all calls to the emergency response organization are simply serviced in the order received.

Based on the foregoing, a solution that may reduce incoming message congestion at an emergency response organization is desirable. Additionally, a solution that may reduce the wait time in message queues for incoming messages to the emergency response organization is desirable. These solutions are likely to increase the probability that incoming messages for more urgent help and more severe situations reach message takers at emergency response organizations sooner than they would currently, especially when a local emergency condition exists.

### SUMMARY

In one aspect, a method for disseminating information relating to a local emergency condition is provided. In one embodiment, the method includes: a) receiving an incoming message originated by a user device at a network node in a communication network, wherein the incoming message is directed to one or more destination devices within a emergency response organization via the communication network through at least the network node; b) determining whether or not the incoming message can be connected to at least one destination device within the emergency response organization without wait time; and c) sending an outgoing message to the user device from the network node in response to determining the incoming message cannot be connected without at least some wait time, wherein the outgoing message provides a status report for at least one local emergency condition within at least a portion of a geographic area served by the emergency response organization and a guidance report with at least one response measure for each corresponding local emergency condition.

In another aspect, an apparatus within a communication network for disseminating information relating to a local emergency condition is provided. In one embodiment, the apparatus includes: an incoming message module for receiving an incoming message originated by a user device in operative communication with the communication network, wherein the incoming message is directed to one or more destination devices within a emergency response organization; a message handling module in operative communication with the incoming message module for determining whether or not the incoming message can be connected to at least one destination device within the emergency response organization without wait time, the message handling module being in operative communication with the one or more destination devices via the communication network; and an outgoing message module in operative communication with the message handling module for sending an outgoing message to the user device in response to the message handling module determining the incoming message cannot be connected without at least some wait time, wherein the outgoing message module is in operative communication with the user device via the communication network, wherein the outgoing message provides a status report for at least one local emergency condition within at least a portion of a geographic area served by the emergency response organization and a guidance report with at least one response measure for each corresponding local emergency condition.

In yet another aspect, a method for disseminating information relating to a local emergency condition is provided. In one embodiment, the method includes: a) receiving an incoming message originated by a user device at a service provider node in a communication network, the communication network also comprising a customer premises node, wherein the incoming message is directed to one or more destination devices within a emergency response organization via the communication network through at least the service provider node and the customer premises node; b) determining whether or not the incoming message can be connected to at least one destination device by the customer premises node within the emergency response organization without wait time; and c) sending an outgoing message to the user device from the service provider node in response to determining the incoming message cannot be connected by the customer premises node without at least some wait time, wherein the outgoing message provides a status report for at least one local emergency condition within at least a portion of a geographic area served by the emergency response organization and a guidance report with at least one response measure for each corresponding local emergency condition.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a flow chart of an exemplary embodiment of a process for disseminating information relating to a local emergency;

FIG. 2, in conjunction with FIG. 1, is a flow chart of another exemplary embodiment of a process for disseminating information relating to a local emergency;

FIG. 3, in conjunction with FIG. 1, is a flow chart of yet another exemplary embodiment of a process for disseminating information relating to a local emergency;

FIG. 4 is a block diagram of an exemplary embodiment of a network node in a communication network for disseminating information relating to a local emergency;

FIG. 5 is a block diagram of an exemplary embodiment of a service provider node in a communication network for disseminating information relating to a local emergency;

FIG. 6 is a block diagram of an exemplary embodiment of a customer premises node in a communication network for disseminating information relating to a local emergency;

FIG. 7 is a flow chart of still another exemplary embodiment of a process for disseminating information relating to a local emergency; and

FIG. 8, in conjunction with FIG. 7, is a flow chart of still yet another exemplary embodiment of a process for disseminating information relating to a local emergency.

### DETAILED DESCRIPTION

Various embodiments of methods and network nodes for disseminating information relating to a local emergency condition (e.g., an event) are disclosed herein. In certain embodiments, the network node includes a service provider node, such as an end office. In other embodiment, the network includes a customer premises node, such as a private branch exchange (PBX).

The methods and network nodes for disseminating information relating to a local emergency condition allow originators (e.g., callers) of messages (e.g., calls) to an emergency response organization (e.g., PSAP) to receive general information that satisfies their needs if they were calling for status or guidance regarding a local emergency condition without having to speak to a message taker (e.g., call taker) for the emergency response organization. Message originators satisfied with the general information are likely to remove themselves from queues at the emergency response organization and to stop attempting further messages. Thus, it is likely that more urgent messages for specific assistance have a higher probability of reaching a message taker sooner than they would if these message originators remained in the queue or attempted further messages. Certain embodiments disclosed herein are complementary. For example, in various embodiments, the network node may include a service provider node with features for disseminating information related to the local emergency condition, a customer premises node with features for disseminating information related to the local emergency condition, or both service provider and customer premises nodes with features for disseminating information related to the local emergency condition.

In one embodiment, the features for disseminating information related to the local emergency condition at the customer premises node may be viewed as a modification to the queuing mechanism (physically or logically) located at the emergency response organization. When the incoming message is to be queued because there is no message taker available and there is an “event” in progress, the message originator (e.g., citizen) is played an announcement while in the message is in queue. The announcement may include the most current information about the event. If this information meets the specific needs of the message originator they are likely to hang up. This releases the corresponding connection (e.g., circuit) to the emergency response organization and allows the message takers to focus on other messages from other originators with emergencies requiring interaction with the message taker. If the announcement does not satisfy the message originator or is unrelated to the originator's emergency, the originator will remain in the queue until they can be connected to a message taker.

Examples of “events” can include: i) short term events such as severe weather, plane crashes, chemical spills, building collapses, riots, etc; ii) medium term events such as floods, power outages, etc.; and iii) long term events such as pandemics (e.g., flu), war, civil unrest, etc. The determination and classification of an “event” and the corresponding information to be provided to the public is a matter of local authority policy. The embodiments described herein address the mechanism by which the information can be conveyed to the public. The announcement can be locally recorded by the emergency response organization (e.g., under authority of a PSAP administrator) and easily changed as the event progresses. Obviously, the embodiments described herein are more likely to reduce message congestion to the emergency response organization, and thereby provide more value, if the announcement is kept current when new information regarding the local emergency condition becomes available.

In another embodiment, if all connections to the emergency response organization are busy, rather than releasing the message with a reorder cause code, the message is routed, for example, to a telephone office announcement system at a service provider node if the call release cause code has been set to “play local emergency announcement.” The message originator would then hear an announcement about the event instead of a reorder tone (e.g., slow busy tone). In this embodiment, the current call is not blocking access to the emergency response organization because the message has been released back to a service provider node (e.g., local originating office or an intermediate office) capable of playing a local emergency announcement. This may be viewed as a more efficient use of network equipment when there are no trunks available to the emergency response organization than merely returning a reorder tone.

Often the trunks to the emergency response organization are dimensioned in relation to the maximum number of message takers and the size of the queue (e.g., buffer) at the emergency response organization to allow trunk congestion to drive flow control for access to the limited resources at the emergency response organization. The use of telephone office local emergency announcements to disseminate information relating to local emergency conditions is consistent with this type of flow control and also provides valuable information to the message originators that are otherwise blocked from reaching the emergency response organization by message congestion.

While traditional telephony terms and equipment may be used herein for the description and examples, the concepts defined herein are equally applicable to all modalities of access in addition to traditional wireline technology. For example, the various embodiments disclosed herein may be implemented using wireline, wireless (e.g., satellite, cellular, WiFi (such as IEEE 802.11), WiMax (such as IEEE 802.16), etc.), text messaging service (e.g., short messaging service (SMS)), e-mail service, internet protocol (IP) communications, voice over IP (VoIP) communications, multimedia communications, and other access methodologies, including future access methodologies. While voice may be used in the description and examples, the concept is equally applicable to text and multimedia formats.

An example of a local emergency condition may be the 2009 H1N1 flu pandemic. In such a case, the announcement provided to message originators that are on hold at the emergency response organization could be something such as “If you are calling about the flu and have symptoms, please hang up now and go to the local hospital emergency room, otherwise stay on the line.”

Another example of a local emergency condition may be a chemical spill. In this example, the announcement provided to message originators that are on hold may state “There is a chemical spill in the XYZ area. The government advises you stay inside, put wet towels by the doors, and monitor the news for updates. The message takers (e.g., 9-1-1 operators) at the emergency response organization have no additional information so please hang up unless your call is for a different emergency.”

The corresponding announcement provided by the service provider node (e.g., telephone office) for the 2009 H1N1 flu pandemic might be “If you are calling about the flu, please hang up now and go to the local hospital emergency room, otherwise hang up now and try again shortly.” Similarly, the corresponding announcement provided by the service provider node for the chemical spill may state “There is a chemical spill in the XYZ area. The government advises you stay inside, put wet towels by the doors, and monitor the news for updates. If you are calling about the chemical spill, please hang up now and check your TV or radio for more information, otherwise hang up now and try again shortly.”

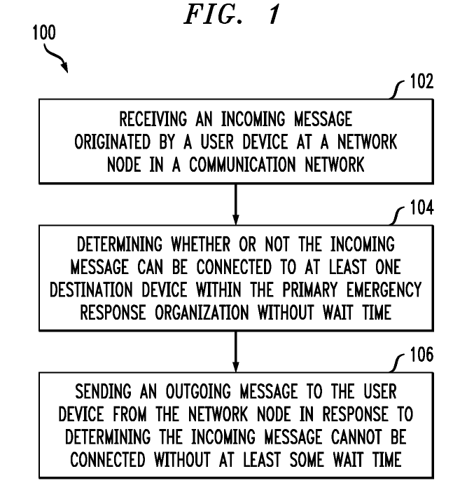

Referring now to the drawings wherein the showings are for purposes of illustrating the exemplary embodiments only and not for purposes of limiting the claimed subject matter, FIG. 1 depicts an exemplary embodiment of a process 100 for disseminating information relating to a local emergency condition that begins at 102 where an incoming message originated by a user device may be received at a network node in a communication network. The incoming message may be directed to a network address associated with one or more destination devices within a primary emergency response organization via the communication network through at least the network node.

At 104, the network node may determine whether or not the incoming message can be connected to at least one destination device within the primary emergency response organization without wait time. Next, an outgoing message may be sent to the user device from the network node in response to determining the incoming message cannot be connected without at least some wait time (106). The outgoing message may provide a status report for at least one local emergency condition within at least a portion of a geographic area served by the primary emergency response organization and a guidance report with at least one response measure for each corresponding local emergency condition.

In another embodiment of the process 100, the incoming message may include a voice call, a text message, a multi-media message, an e-mail message, or any suitable message type in any combination. In yet another embodiment of the process 100, the primary emergency response organization may include a PSAP, an emergency call center, a law enforcement organization, a fire emergency response organization, a medical emergency response organization, a search emergency response organization, a rescue emergency response organization, a hazardous materials (HAZMAT) emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still yet another embodiment of the process 100, the network node may include a service provider node, a service provider switch, a circuit switching center, a mobile switching center (MSC), a base station, a packet switching center, an Internet service provider (ISP), a VoIP service provider, an e-mail service provider, a multi-service operator (MSO), a customer premises node, an emergency response organization switch, a PSAP switching center, a PBX, or any suitable type of network node. Of course, a given network node may include multiple types of network nodes in any suitable combination.

In another embodiment of the process 100, the communication network may include a public switched telephone network (PSTN), a wireless telephone network, a cellular telephone network, a satellite telephone network, an IP network, a VoIP network, a local area network (LAN), a wide area network (WAN), a metropolitan area network (MAN), or any suitable type of communication network in any combination.

In yet another embodiment of the process 100, the user device may include a landline telephone, a wireless telephone, a cellular telephone, a satellite telephone, a portable computer device, a computer workstation, an IP telephone, or any suitable user device in any combination. In still another embodiment of the process 100, the network address may include a service access code (SAC), a directory number, a telephone number, an IP address, an e-mail address, or any suitable network address. Of course, a given network address may include multiple types of network addresses in any suitable combination. In still yet another embodiment of the process 100, the one or more destination devices may include a landline telephone, a wireless telephone, a cellular telephone, a satellite telephone, a portable computer device, a computer workstation, an IP telephone, or any suitable destination device in any combination.

In another embodiment, the process 100 may also include determining the incoming message cannot be connected to any destination device in 104 based at least in part on determining no destination device within the primary emergency response organization is available to receive the incoming message. This embodiment may also include storing the incoming message in a message queue for the primary emergency response organization in conjunction with sending the outgoing message in 106. Alternatively, the embodiment being described may also include releasing the incoming message and returning a destination busy notification to the user device after sending the outgoing message in 106.

In yet another embodiment, the process 100 may also include determining the incoming message cannot be connected to any destination device in 104 based at least in part on determining that a message queue for the primary emergency response organization is full. This embodiment may also include releasing the incoming message and returning a destination busy notification to the user device after sending the outgoing message in 106. Alternatively, the embodiment being described may also include routing the incoming message to an alternate emergency response organization after sending the outgoing message in 106. In this embodiment, the alternate emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still another embodiment of the process 100, the outgoing message may include an audible announcement, a text message, a multi-media message, an e-mail message, or any suitable type of message. Of course, a given outgoing message may include multiple types of messages in any suitable combination. In still yet another embodiment of the process 100, the status report in the outgoing message may be periodically updated during the corresponding local emergency condition to provide near real-time status information. In another embodiment of the process 100, the guidance report in the outgoing message may be periodically updated during the corresponding local emergency condition to provide near real-time guidance information.

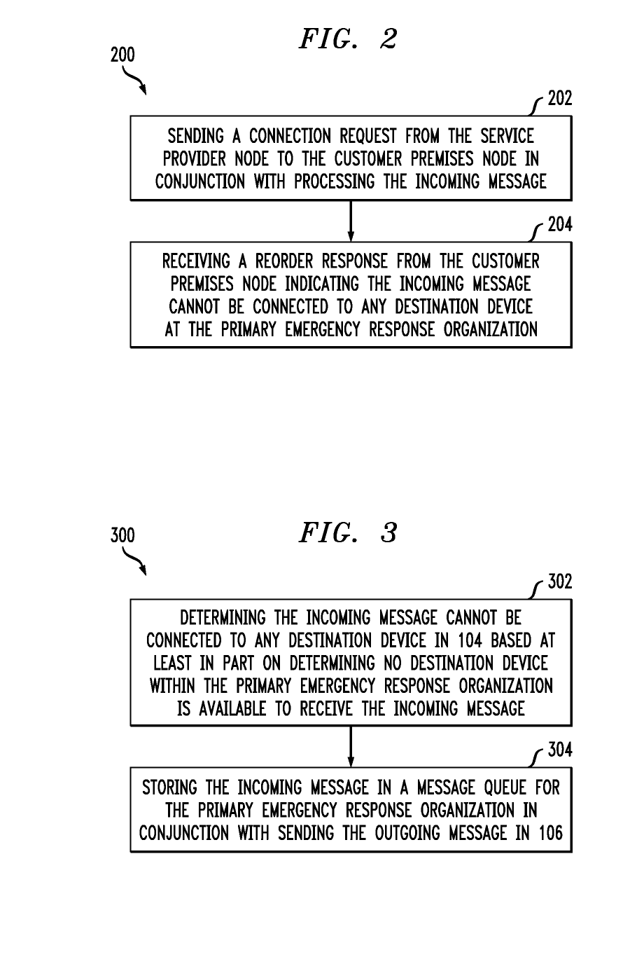

With reference to FIGS. 1 and 2, in another exemplary embodiment of a process 200 for disseminating information relating to a local emergency condition the network node may include a service provider node in operative communication with the one or more destination devices via a customer premises node within the primary emergency response organization. The process 200 may include 102, 104, and 106 of FIG. 1. The process 200 may also include sending a connection request from the service provider node to the customer premises node in conjunction with processing the incoming message (202). At 204, a reorder response may be received from the customer premises node indicating the incoming message cannot be connected to any destination device at the primary emergency response organization.

In another embodiment of the process 200, the reorder response may be indicative of: i) a message queue for the primary emergency response organization being full, ii) no destination device within the primary emergency response organization being available to receive the incoming message, or iii) both i) and ii). In yet another embodiment, the process 200 may also include releasing the incoming message and returning a destination busy notification to the user device after sending the outgoing message in 106. Alternatively, in still another embodiment, the process 200 may also include routing the incoming message to an alternate emergency response organization after sending the outgoing message in 106.

With reference to FIGS. 1 and 3, in yet another exemplary embodiment of a process 300 for disseminating information relating to a local emergency condition the network node may include a customer premises node within the primary emergency response organization in operative communication with the one or more destination devices. The process 300 may include 102, 104, and 106 of FIG. 1. The process 300 may also include determining the incoming message cannot be connected to any destination device in 104 based at least in part on determining no destination device within the primary emergency response organization is available to receive the incoming message (302). At 304, the incoming message may be stored in a message queue for the primary emergency response organization in conjunction with sending the outgoing message in 106.

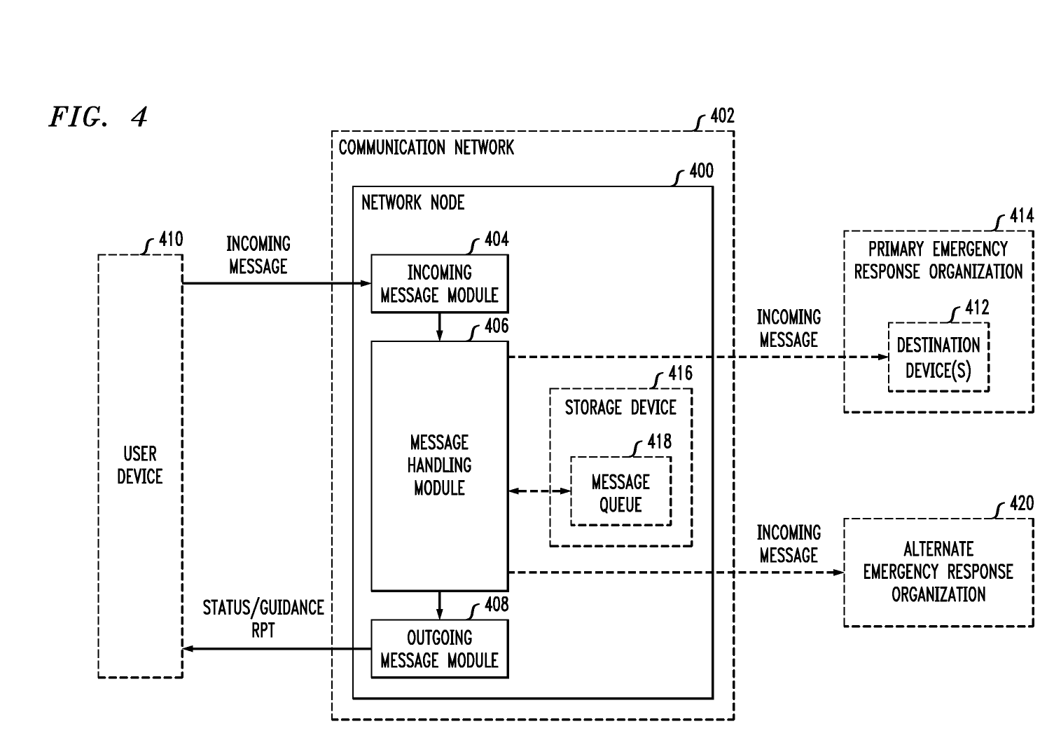

With reference to FIG. 4, an exemplary embodiment of a network node 400 in a communication network 402 for disseminating information relating to a local emergency condition may include an incoming message module 404, a message handling module 406, and an outgoing message module 408. The incoming message module 404 may receive an incoming message originated by a user device 410 in operative communication with the communication network 402. The incoming message may be directed to a network address associated with one or more destination devices 412 within a primary emergency response organization 414.

The message handling module 406 may be in operative communication with the incoming message module 404 and may determine whether or not the incoming message can be connected to at least one destination device 412 within the primary emergency response organization 414 without wait time. The message handling module 406 may be in operative communication with the one or more destination devices 412 via the communication network 402.

The outgoing message module 408 may be in operative communication with the message handling module 406 and may send an outgoing message to the user device 410 in response to the message handling module 406 determining the incoming message cannot be connected without at least some wait time. The outgoing message module 408 may be in operative communication with the user device 410 via the communication network 402. The outgoing message may provide a status report for at least one local emergency condition within at least a portion of a geographic area served by the primary emergency response organization 414 and a guidance report with at least one response measure for each corresponding local emergency condition.

In another embodiment of the network node 400, the incoming message may include a voice call, a text message, a multi-media message, an e-mail message, or any suitable message type in any combination. In yet another embodiment of the network node 400, the primary emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still yet another embodiment, the network node 400 may include a service provider node, a service provider switch, a circuit switching center, an MSC, a base station, a packet switching center, an ISP, a VoIP service provider, an e-mail service provider, an MSO, a customer premises node, an emergency response organization switch, a PSAP switching center, a PBX, or any suitable type of network node. Of course, a given network node may include multiple types of network nodes in any suitable combination.

In another embodiment of the network node 400, the communication network 402 may include a PSTN, a wireless telephone network, a cellular telephone network, a satellite telephone network, an IP network, a VoIP network, a LAN, a WAN, a MAN, or any suitable type of communication network in any combination.

In yet another embodiment of the network node 400, the user device 410 may include a landline telephone, a wireless telephone, a cellular telephone, a satellite telephone, a portable computer device, a computer workstation, an IP telephone, or any suitable user device in any combination. In still another embodiment of the network node 400, the network address may include a SAC, a directory number, a telephone number, an IP address, an e-mail address, or any suitable network address. Of course, a given network address may include multiple types of network addresses in any suitable combination. In still yet another embodiment of the network node 400, the one or more destination devices 412 may include a landline telephone, a wireless telephone, a cellular telephone, a satellite telephone, a portable computer device, a computer workstation, an IP telephone, or any suitable destination device in any combination.

In another embodiment of the network node 400, the message handling module 406 may determine the incoming message cannot be connected to any destination device without at least some wait time based at least in part on determining no destination device within the primary emergency response organization is available to receive the incoming message. This embodiment may also include a storage device 416 in operative communication with the message handling module 406 for storing the incoming message in a message queue 418 for the primary emergency response organization 414. The message handling module 406 may place the incoming message in the message queue 418 after determining no destination device 412 is available to receive the incoming message and in conjunction with the outgoing message module 408 sending the outgoing message to the user device 410. Alternatively, in the embodiment being described the outgoing message module 408 may release the incoming message and return a destination busy notification to the user device 410 after sending the outgoing message.

In yet another embodiment of the network node 400, the message handling module 406 may determine the incoming message cannot be connected to any destination device 412 without at least some wait time based at least in part on determining a message queue 418 for the primary emergency response organization 414 is full. In this embodiment, the outgoing message module 408 may release the incoming message and may return a destination busy notification to the user device 410 after sending the outgoing message. Alternatively, in the embodiment being described, the message handling module 406 may route the incoming message to an alternate emergency response organization 420 after the outgoing message module sends the outgoing message to the user device 410. In this embodiment, the alternate emergency response organization 420 may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still another embodiment of the network node 400, the outgoing message may include an audible announcement, a text message, a multi-media message, an e-mail message, or any suitable type of message. Of course, a given outgoing message may include multiple types of messages in any suitable combination. In still yet another embodiment of the network node 400, the status report in the outgoing message may be periodically updated during the corresponding local emergency condition to provide near real-time status information. In another embodiment of the network node 400, the guidance report in the outgoing message may be periodically updated during the corresponding local emergency condition to provide near real-time guidance information.

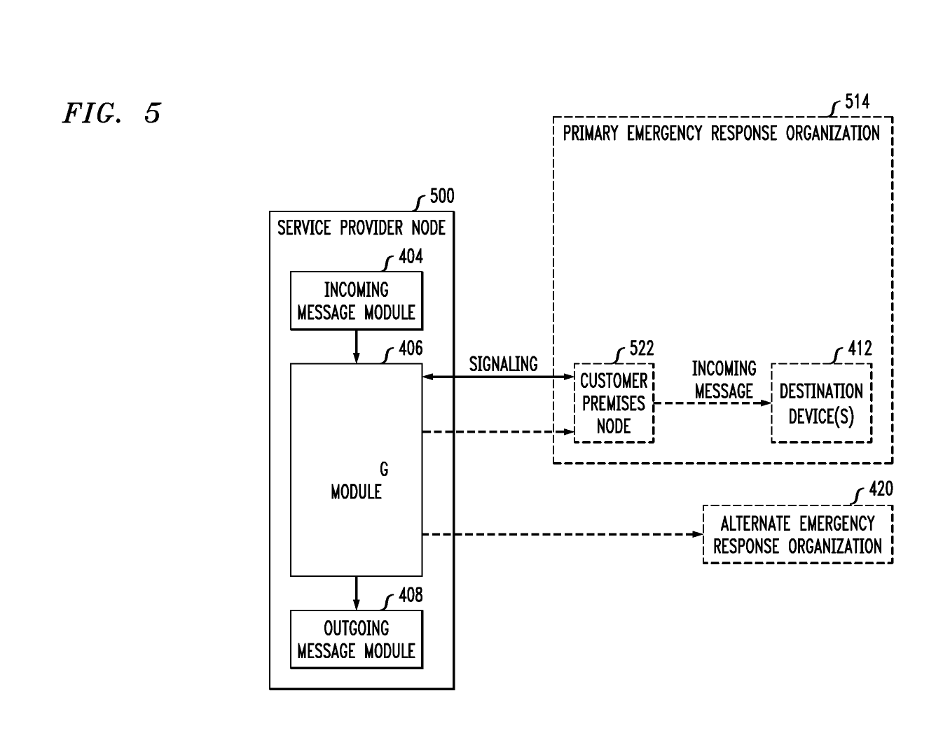

With reference to FIG. 5, an exemplary embodiment of a service provider node 500 in a communication network 502 for disseminating information relating to a local emergency condition may be in operative communication with the one or more destination devices 412 via a customer premises node 522 within the primary emergency response organization 514. The service provider node 500 may include the incoming message module 404, message handling module 406, and outgoing message module 408 of FIG. 4. The message handling module 406 may send a connection request to the customer premises node 522 in connection with processing the incoming message and may receive a reorder response from the customer premises node 522 indicating the incoming message cannot be connected to any destination device 412 within the primary emergency response organization 514.

In another embodiment of the service provider node 500, the reorder response may be indicative of: i) a message queue for the primary emergency response organization 514 being full, ii) no destination devices 412 within the primary emergency response organization 514 being available to receive the incoming message, or iii) both i) and ii). In yet another embodiment of the service provider node 500, the outgoing message module 408 may release the incoming message and may return a destination busy notification to the user device 410 after sending the outgoing message. Alternatively, in still another embodiment of the service provider node 500, the message handling module 406 may route the incoming message to an alternate emergency response organization 420 after the outgoing message module 408 sends the outgoing message to the user device 410.

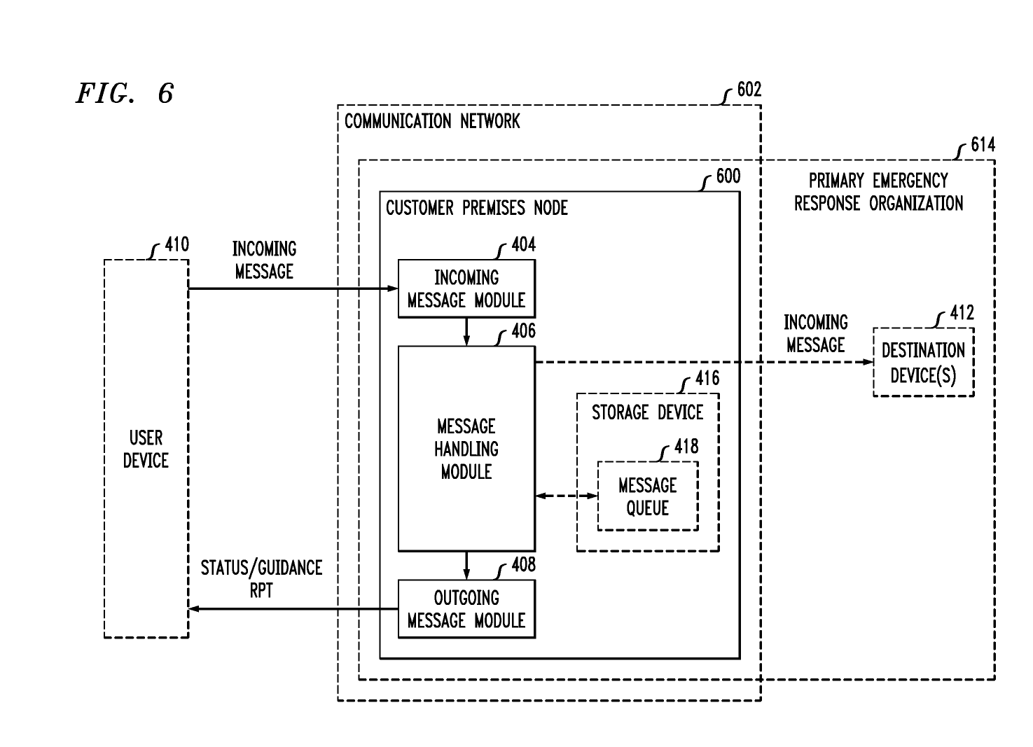

With reference to FIG. 6, an exemplary embodiment of a customer premises node 600 in a communication network 602 for disseminating information relating to a local emergency condition may be disposed within the primary emergency response organization 614 in operative communication with the one or more destination devices 412. The customer premises node 600 may include the incoming message module 404, message handling module 406, and outgoing message module 408 of FIG. 4. The message handling module 406 may determine the incoming message cannot be connected to any destination device 412 without at least some wait time based at least in part on determining no destination device 412 within the primary emergency response organization 614 is available to receive the incoming message. In this embodiment, the customer premises node 600 may also include a storage device 416 in operative communication with the message handling module 406 for storing the incoming message in a message queue 418 for the primary emergency response organization 614. The message handling module 406 may place the incoming message in the message queue 418 after determining no destination device 412 is available to receive the incoming message and in conjunction with the outgoing message module 408 sending the outgoing message to the user device 410.

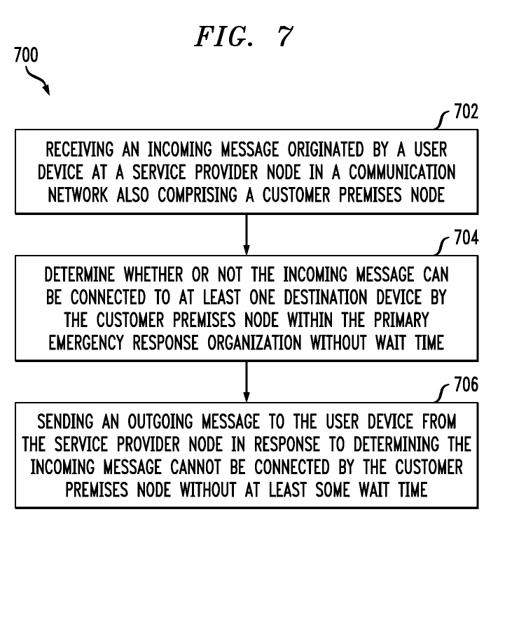

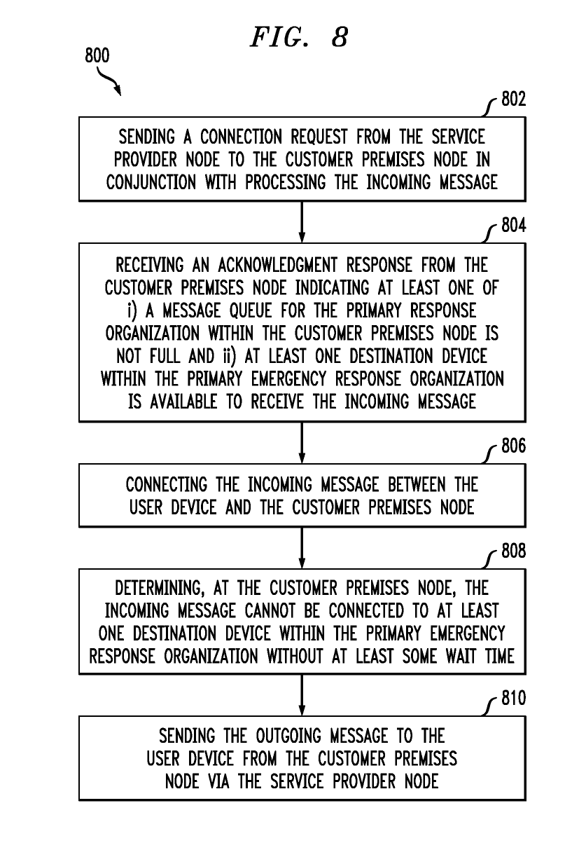

With reference to FIG. 7, still another exemplary embodiment of a process 700 for disseminating information relating to a local emergency condition begins at 702 where an incoming message originated by a user device may be received at a service provider node in a communication network. The communication network may also include a customer premises node. The incoming message may be directed to a network address associated with one or more destination devices within a primary emergency response organization via the communication network through at least the service provider node and the customer premises node.

At 704, the service provider node may determine whether or not the incoming message can be connected to at least one destination device by the customer premises node within the primary emergency response organization without wait time. Next, an outgoing message may be sent to the user device from the service provider node in response to determining the incoming message cannot be connected by the customer premises node without at least some wait time (706). The outgoing message may provide a status report for at least one local emergency condition within at least a portion of a geographic area served by the primary emergency response organization and a guidance report with at least one response measure for each corresponding local emergency condition.

In another embodiment of the process 700, the incoming message may include a voice call, a text message, a multi-media message, an e-mail message, or any suitable message in any combination. In yet another embodiment of the process 700, the primary emergency response organization may include a PSAP, an emergency call center, a law enforcement organization, a fire emergency response organization, a medical emergency response organization, a search emergency response organization, a rescue emergency response organization, a HAZMAT emergency response organization, a traffic safety organization, a traffic control organization, a homeland security organization, a military organization, a government weather service, a government communication service, a government executive organization, or any suitable emergency response organization. Of course, a given emergency response organization may provide multiple types of emergency response services in any suitable combination.

In still another embodiment of the process 700, the service provider node may include a service provider switch, a circuit switching center, an MSC, a base station, a packet switching center, an ISP, a VoIP service provider, an e-mail service provider, an MSO, or any suitable type of service provider node. Of course, a given service provider node may include multiple types of service provider nodes in any suitable combination. In still yet another embodiment of the process 700, the customer premises node may include an emergency response organization switch, a PSAP switching center, a PBX, or any suitable type of customer premises node. Of course, a given customer premises node may include multiple types of customer premises nodes in any suitable combination.

In another embodiment of the process 700, the communication network may include a PSTN, a wireless telephone network, a cellular telephone network, a satellite telephone network, an IP network, a VoIP network, a LAN, a WAN, a MAN, or any suitable type of communication network in any combination.

In yet another embodiment of the process 700, the user device may include a landline telephone, a wireless telephone, a cellular telephone, a satellite telephone, a portable computer device, a computer workstation, an IP telephone, or any suitable user device in any combination. In still another embodiment of the process 700, the network address may include a SAC, a directory number, a telephone number, an IP address, an e-mail address, or any suitable network address. Of course, a given network address may include multiple types of network addresses in any suitable combination. In still yet another embodiment of the process 700, the one or more destination devices may include a landline telephone, a wireless telephone, a cellular telephone, a satellite telephone, a portable computer device, a computer workstation, an IP telephone, or any suitable destination device in any combination.

In another embodiment, the process 700 may also include sending a connection request from the service provider node to the customer premises node in conjunction with processing the incoming message. In this embodiment, a reorder response may then be received from the customer premises node indicating the incoming message cannot be connected to any destination device at the primary emergency response organization. In the embodiment being described, the reorder response may be indicative of: i) a message queue for the primary emergency response organization being full, ii) no destination device within the primary emergency response organization being available to receive the incoming message, or iii) both i) and ii). In this embodiment, the process 700 may also include releasing the incoming message and returning a destination busy notification to the user device after sending the outgoing message in 706. Alternatively, in the embodiment being described, the process 700 may also include routing the incoming message to an alternate emergency response organization after sending the outgoing message in 706.

With reference to FIGS. 7 and 8, still yet another exemplary embodiment of a process 800 for disseminating information relating to a local emergency condition includes 702, 704, and 706 of FIG. 7. The process 800 also may include sending a connection request from the service provider node to the customer premises node in conjunction with processing the incoming message (802). At 804, an acknowledgment response may be received from the customer premises node indicating: i) a message queue for the primary response organization within the customer premises node is not full, ii) at least one destination device within the primary emergency response organization is available to receive the incoming message, or iii) both i) and ii). Next, the incoming message may be connected between the user device and the customer premises node (806). At 808, the customer premises node may determine the incoming message cannot be connected to at least one destination device within the primary emergency response organization without at least some wait time. Next, the outgoing message may be sent to the user device from the customer premises node via the service provider node (810).

In another embodiment, the process 800 may also include storing the incoming message in a message queue for the primary emergency response organization at the customer premises node in conjunction with sending the outgoing message in 706 and 810.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method for disseminating information relating to a local emergency condition, comprising:
a) receiving an incoming message originated by a user device at a network node in a communication network, wherein the incoming message is directed to one or more destination devices within a emergency response organization via the communication network through at least the network node;
b) determining whether or not the incoming message can be connected to at least one destination device within the emergency response organization without wait time; and
c) sending an outgoing message to the user device from the network node in response to determining the incoming message cannot be connected without at least some wait time, wherein the outgoing message provides a status report for at least one local emergency condition within at least a portion of a geographic area served by the emergency response organization and a guidance report with at least one response measure for each corresponding local emergency condition.

2. The method of claim 1, further comprising:
d) determining the incoming message cannot be connected to any destination device in b) based at least in part on determining no destination device within the emergency response organization is available to receive the incoming message.

3. The method of claim 2, further comprising:
e) storing the incoming message in a message queue for the emergency response organization in conjunction with sending the outgoing message in c).

4. The method of claim 2, further comprising:
e) releasing the incoming message and returning a destination busy notification to the user device after sending the outgoing message in c).

5. The method of claim 1, further comprising:
d) determining the incoming message cannot be connected to any destination device in b) based at least in part on determining that a message queue for the emergency response organization is full.

6. The method of claim 5, further comprising:
e) releasing the incoming message and returning a destination busy notification to the user device after sending the outgoing message in c).

7. The method of claim 5, further comprising:
e) routing the incoming message to an alternate emergency response organization after sending the outgoing message in c).

8. The method of claim 1 wherein the status report in the outgoing message is periodically updated during the corresponding local emergency condition to provide near real-time status information.

9. The method of claim 1 wherein the guidance report in the outgoing message is periodically updated during the corresponding local emergency condition to provide near real-time guidance information.

10. The method of claim 1, wherein the network node includes a service provider node in operative communication with the one or more destination devices via a customer premises node within the emergency response organization, the method further comprising:
d) sending a connection request from the service provider node to the customer premises node in conjunction with processing the incoming message; and
e) receiving a reorder response from the customer premises node indicating the incoming message cannot be connected to any destination device at the emergency response organization.

11. The method of claim 10 wherein the reorder response is indicative of at least one of: i) a message queue for the emergency response organization being full and ii) no destination device within the emergency response organization being available to receive the incoming message.

12. The method of claim 10, further comprising:
f) releasing the incoming message and returning a destination busy notification to the user device after sending the outgoing message in c).

13. The method of claim 10, further comprising:
f) routing the incoming message to an alternate emergency response organization after sending the outgoing message in c).

14. The method of claim 1, wherein the network node includes a customer premises node within the emergency response organization in operative communication with the one or more destination devices, the method further comprising:
d) determining the incoming message cannot be connected to any destination device in b) based at least in part on determining no destination device within the emergency response organization is available to receive the incoming message; and
e) storing the incoming message in a message queue for the emergency response organization in conjunction with sending the outgoing message in c).

15. An apparatus within a communication network for disseminating information relating to a local emergency condition, comprising:
an incoming message module for receiving an incoming message originated by a user device in operative communication with the communication network, wherein the incoming message is directed to one or more destination devices within a emergency response organization;
a message handling module in operative communication with the incoming message module for determining whether or not the incoming message can be connected to at least one destination device within the emergency response organization without wait time, the message handling module being in operative communication with the one or more destination devices via the communication network; and
an outgoing message module in operative communication with the message handling module for sending an outgoing message to the user device in response to the message handling module determining the incoming message cannot be connected without at least some wait time, wherein the outgoing message module is in operative communication with the user device via the communication network, wherein the outgoing message provides a status report for at least one local emergency condition within at least a portion of a geographic area served by the emergency response organization and a guidance report with at least one response measure for each corresponding local emergency condition.

16. The apparatus of claim 15 wherein the message handling module determines the incoming message cannot be connected to any destination device without at least some wait time based at least in part on determining no destination device within the emergency response organization is available to receive the incoming message.

17. The apparatus of claim 16, further comprising:
a storage device in operative communication with the message handling module for storing the incoming message in a message queue for the emergency response organization, wherein the message handling module places the incoming message in the message queue after determining no destination device is available to receive the incoming message and in conjunction with the outgoing message module sending the outgoing message to the user device.

18. The apparatus of claim 15 wherein the message handling module determines the incoming message cannot be connected to any destination device without at least some wait time based at least in part on determining a message queue for the emergency response organization is full.

19. The apparatus of claim 15 wherein the apparatus comprises a service provider node in operative communication with the one or more destination devices via a customer premises node within the emergency response organization, the service provider node comprising the incoming message module, message handling module, and outgoing message module, wherein the message handling module sends a connection request to the customer premises node in connection with processing the incoming message and receives a reorder response from the customer premises node indicating the incoming message cannot be connected to any destination device within the emergency response organization.

20. The apparatus of claim 15, wherein the apparatus comprises a customer premises node within the emergency response organization in operative communication with the one or more destination devices, the customer premises node comprising the incoming message module, message handling module, and outgoing message module, wherein the message handling module determines the incoming message cannot be connected to any destination device without at least some wait time based at least in part on determining no destination device within the emergency response organization is available to receive the incoming message, the customer premises node further comprising:
a storage device in operative communication with the message handling module for storing the incoming message in a message queue for the emergency response organization, wherein the message handling module places the incoming message in the message queue after determining no destination device is available to receive the incoming message and in conjunction with the outgoing message module sending the outgoing message to the user device.

21. A method for disseminating information relating to a local emergency condition, comprising:
a) receiving an incoming message originated by a user device at a service provider node in a communication network, the communication network also comprising a customer premises node, wherein the incoming message is directed to one or more destination devices within a emergency response organization via the communication network through at least the service provider node and the customer premises node;
b) determining whether or not the incoming message can be connected to at least one destination device by the customer premises node within the emergency response organization without wait time; and
c) sending an outgoing message to the user device from the service provider node in response to determining the incoming message cannot be connected by the customer premises node without at least some wait time, wherein the outgoing message provides a status report for at least one local emergency condition within at least a portion of a geographic area served by the emergency response organization in conjunction with and a guidance report with at least one response measure for each corresponding local emergency condition.

22. The method of claim 21, further comprising:
d) sending a connection request from the service provider node to the customer premises node in conjunction with processing the incoming message; and
e) receiving a reorder response from the customer premises node indicating the incoming message cannot be connected to any destination device at the emergency response organization.

23. The method of claim 22, further comprising:
f) releasing the incoming message and returning a destination busy notification to the user device after sending the outgoing message in c).

24. The method of claim 21, further comprising:
d) sending a connection request from the service provider node to the customer premises node in conjunction with processing the incoming message;
e) receiving an acknowledgment response from the customer premises node indicating at least one of: i) a message queue for the response organization within the customer premises node is not full and ii) at least one destination device within the emergency response organization is available to receive the incoming message;
f) connecting the incoming message between the user device and the customer premises node;
g) determining, at the customer premises node, the incoming message cannot be connected to at least one destination device within the emergency response organization without at least some wait time; and
h) sending the outgoing message to the user device from the customer premises node via the service provider node.

25. The method of claim 24, further comprising:
i) storing the incoming message in a message queue for the emergency response organization at the customer premises node in conjunction with sending the outgoing message in c) and h).
